(19) United States
(12) Patent Application Publication
(10) Pub. No.: US 2010/0031709 A1
(43) Pub. Date: Feb. 11, 2010

(54) Handcuffs

(76) Inventors: Keun Jung Kim, Clifton, VA (US); Kay KC Kim, Clifton, VA (US)

Correspondence Address: Keun Jung Kim, 6823 Union Mill Rd., Clifton, VA, 20124, US

(21) Appl. No.: 12/320,857

(22) Filed: Feb. 6, 2009

Related U.S. Application Data
(63) Continuation-in-part of application No. 12/007,395, filed on Jan. 10, 2008, now abandoned.

(51) Int. Cl. E05B 75/00

(52) U.S. Cl. 70/16

(57) ABSTRACT

A set of handcuffs which has a first bracelet, a second bracelet, and control device, one-way locking mechanism, retractable/expendable mechanism, retractable/expendable track. In first embodiment main/first bracelet comprises a retractable/expendable mechanism. One end of line is attached to the second bracelet and the other end of the line is attached to the retractable/expendable mechanism. When first bracelet is open, line are to be move in or out freely but once first bracelet is closed line which is attached to second bracelet are to be in retraction mode only, until first bracelet is open again.

A second embodiment comprise extendable/retractable track with docking hole to secure second bracelet in place.

### CROSS-REFERENCE TO RELATED APPLICATIONS

This application is a continuation-in-part of application Ser. No. 12/007,395 filed on Jan. 10, 2008.

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING SPPENDIX SUBMITTED ON A COMPACT DISC

(Not applicable)

### BACKGROUND OF THE INVENTION

1) Field of the Invention

This invention relates to restraining systems such as handcuffs or shackles which may be applied to a subject while the hands or feet are far apart and, once locked, the distance between the bracelets of the restraining systems may decrease, but cannot increase.

2) Description of the Related Art

It is known to use a restraining system to hold a subject's hands together. When using the restraining systems disclosed in the prior art, three or four arresting officer must use overpowering force to put a handcuff or restraining system on a resisting subject.

The restraint devices of U.S. Pat. No. 539,650 issued to Searle on May, 1895 and U.S. Pat. No. 5,581,856 issued to Miller et al on December, 1996 contain locking clips which are permanently attached to straps or chains but are slide able to different lengths to tie down a subject. These locking clips may not be detached from the restraint device and are necessary for the operation of the restraint device.

U.S. Pat. No. 372,510 issued to Bean on November, 1887 teaches handcuffs comprising a central holder having two conventional key lock pawl mechanisms having ratchet teeth for one-way clutch engagement with two restraint members, spacers within the housing for engaging the key lock pawl mechanisms, and coil springs for biasing the key pawl into engagement with the restraint members, which key lock pawl mechanisms are interrelated such that a single key operation releases both sets of ratchets and pawls to open the handcuffs.

The device in U.S. Pat. No. 6,026,661 issued to Spiropoulus on February, 2000 allows the arresting officers to put handcuffs on the subject with ease, but they have to use force by using a ratcheting mechanism similar in design to a fishing reel. Such mechanism allows the arresting officers to, in effect, “reel in” each restraint until such restraints are brought together in a close relationship. This is a better device than the fixed-length handcuffs, but when the subject resists, the ratcheting mechanical reel device could become a dangerous weapon as the subject could swing it at the arresting officers.

U.S. Pat. No. 4,024,736 issued to De Michieli on May, 1977 describes a restraining mechanism which allows the subject to walk, but not run due to one-way speed limiting braking mechanism. Walking speeds up to 350 feet per minute are allowed. The De Michieli device would not be suitable for use as handcuffs. The system of the De Michieli Patent is not intended to be useful for constraining a resisting subject.

U.S. Pat. No. 6,360,747 issue to Velarde et al on March, 2002 shows a restraining system which comprises handcuffs and leg shackles. The overall length of the restraining system can be adjusted between a tight position to constrain a violent subject and a loose position which allows the subject to walk with difficulty. In this system, the distance between the handcuffs is always constant.

U.S. Pat. No. 7,210,317. Beane et al teach a remote apparatus for an handcuff are manually actuated. When subject is cuffed and handcuff is not actuated subject have all the free movement.

### BRIEF SUMMARY OF THE INVENTION

The present invention solves the above-noted problems by providing restraining devices which have an adjustable distance between the bracelets of the devices.

In using the system of the Spiropoulus invention, the authority must take an active role in bringing the subject's hands together. In the present invention, the bracelets are brought together automatically whenever the subject decreases the distance between the bracelets. The distance will never increase. No force by an authority is required.

In use, the system of De Michieli will retract and lengthen. The locking mechanism will engage only if the subject is traveling at a rate of speed of greater than 350 feet per minute. In the present invention, the bracelets may move closer together but will not move farther apart. The bracelets of the handcuffs or shackles may be applied to the subject while the subject's hands or feet are far apart and will retract automatically to a predetermined distance. Thus, the arresting officer does not need to have the hands of the subject together in order to apply the restraint devices. In the present invention the restraint device maintain the bracelets locked while the bracelets are retracting, thus providing a continual limiting of movement of the subject while the subject is securely locked.

This invention is designed to help the arresting officer. When the subject resists arrest, this restraining device gives the officer the freedom of not having to force the subject's hands together to put the restraining device onto the subject. The restraint device is not fixed in length. Rather, it may become any length which is required and it may retract to a predetermined size. The first advantage of this restraint device over the prior art is that it may become any length by merely opening the device's bracelet on the main holder without a key. The second advantage is that a retracting device retracts one of the bracelets automatically to the original position once the restraint device is on the subject. The third advantages is that the distance between the bracelets may not increase, but may only decrease. The fourth advantage is that when one bracelet is on the subject, the arresting officer can stay away from a dangerous subject and lock the other bracelet to any anchored place to restrain the subject. This is made possible by an automatic retraction/extension length-control feature of the restraint devices. A fifth advantage of the present system over the prior art systems is that shackles of the present invention may be used as leg cuff to allow the subject to walk or run with officer, with use of a line stopper. The sixth advantage is, in the event the subject try to run away from officer, the line stopper may be detached and the shackles will go into their automatic retraction mode. In this even, the bracelets of the shackles will be drawn closer together but will never get farther apart. Thus, the subject cannot escape. The restraining system of this invention is made up of a first bracelet with main holder having a retraction/extension mechanism, and a second bracelet attached by a line/strap to the retraction/extension mechanism. A line/strap stopper may be attached to the line to allow supervised freedom of movement. The restraining system of the first embodiment of the invention is preferably made up of a first bracelet with main holder, and a second bracelet. The upper section of the first bracelet contains ratchets which mesh with corresponding pawls of a locking/unlocking mechanism located in the main holder to allow the upper section to travel downwardly in a tightening direction, but do not allow the upper section to travel upwardly in a loosening direction. The bracelet also contains a control device which, when the bracelet is locked, it will release the one-way locking mechanism from control device. The one-way locking mechanism engages and disengages with the retraction/extension mechanism, which has line/strap attached to and a line/strap which is attached to the second bracelet. When the first bracelet is closed, gears of the one-way locking mechanism and the retraction/extension mechanism are engaged, the retraction/extension mechanism allows the line to be retracted, but not extended. The restraint devices of the second embodiment, like those of the first embodiment, are made up of a first bracelet and second bracelet but without retraction/extension mechanism and line. Instead second embodiment's first bracelet have extendable/retractable track and lock/unlock coupling device in order to put first and second bracelet together at desirable length. In a unexpected resistance from subject second embodiment can be used like extendable police stick. The third embodiment are like first embodiment but instead of retraction/extension mechanism it has stunning electrical device. Instead of line, a coupling device will put first and second bracelet together, also coupling device work as off switch for stunning electrical device. Stunning device can be set for desire level of power or time.

### BRIEF DESCRIPTION OF THE SEVERAL VIEWS OF THE DRAWINGS

FIG. 1 is a front view in cut-away of the set of handcuffs of the first embodiment of the present invention in the closed mode with the line/strap extended in retract only mode.

FIG. 2 is a front view in cut-away of the set of handcuffs of the first embodiment of the present invention in the open mode with the line/strap in extendable/retractable mode.

FIG. 3 is a main/first bracelet with extendable track retracted to the main/first bracelet with track locking/unlocking mechanism.

FIG. 4 is a second bracelet with locking/unlocking coupling.

FIG. 5 is a main/first bracelet enlarged area of locking/unlocking mechanism for extendable track.

FIG. 6 is a main/first bracelet and second bracelet put together in extended track mode.

FIG. 7 is a main/first bracelet with stunning unit and also it is attachable by second bracelet.

FIG. 8 is a main/first bracelet with stunning unit and second bracelet attached.

### DETAILED DESCRIPTION OF THE INVENTION

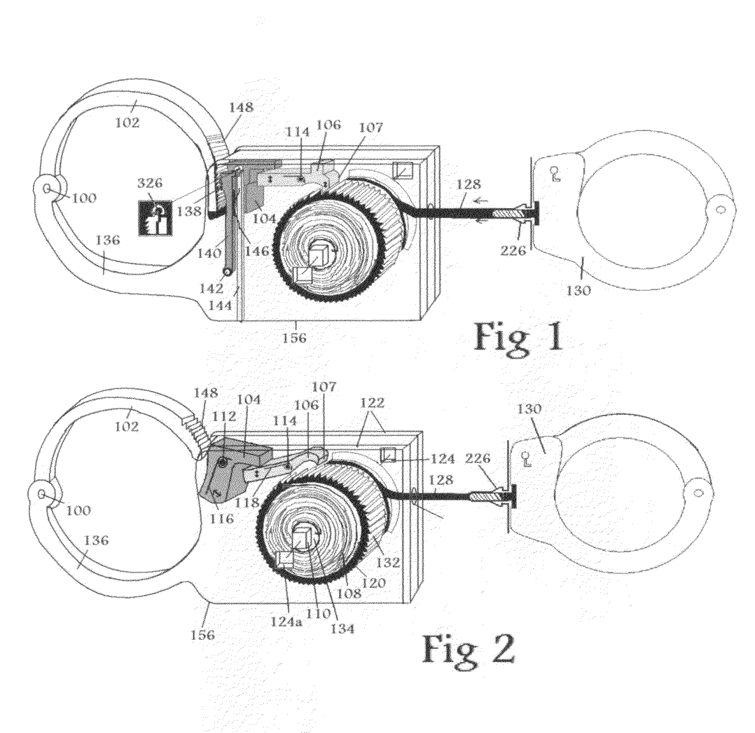

FIG. 1 Once upper section 102 of the bracelet 136 is closed. Upper section 102 of the bracelet 136 ratchet 148 is lock with locking mechanism's 140 pawl 138. In this condition, the upper section 102 cannot be open without key. Same time upper section's 102 ratchet 148 is pressing the control device 104, in order to, not press the one-way locking device 106, one way locking device 106 is pivot 114 to cover plate 122 and spring 118 is pushing left up and right side down to be engaged with retractable/extendable unit 120. In this condition, retractable/extendable unit 120 will only allow retraction of line/strap 128 into main/first bracelet unit 156, also pulls the second bracelet 130 since it is attached to line/strap 128. Key hole 326 and locking/unlocking mechanism 140 with spring 146, double locking mechanism 144, fit other side of locking mechanism's 140 pawl 138, in order to lock the movement of locking mechanism 140 with spring 146. This way upper section 102 cannot be tighten or loose from locking/unlocking mechanism 140. Also second bracelet 130 having attachable/detachable locking device 226, lock securely into main/first bracelet unit 156.

FIG. 2 Once upper section 102 of the bracelet 136 having ratchets 148 is attached by pivot pin 100. When upper section 102 of the bracelet 136 is open as shown, ratchet 148 is not pressing the control device 104, control device pivot pin 112 attached to cover plate 122 and has stronger spring 116 tension than one way locking device's 106 spring 118. Due to stronger spring 116 control device's 104 right side is pressing down left side of one way locking mechanism 114 which release locking from right side of one way locking device 106 retractable/extendable units 120 gear 132. This way line/strap 128 can be extend or retract, which second bracelet 130 is attached to line/strap 128.

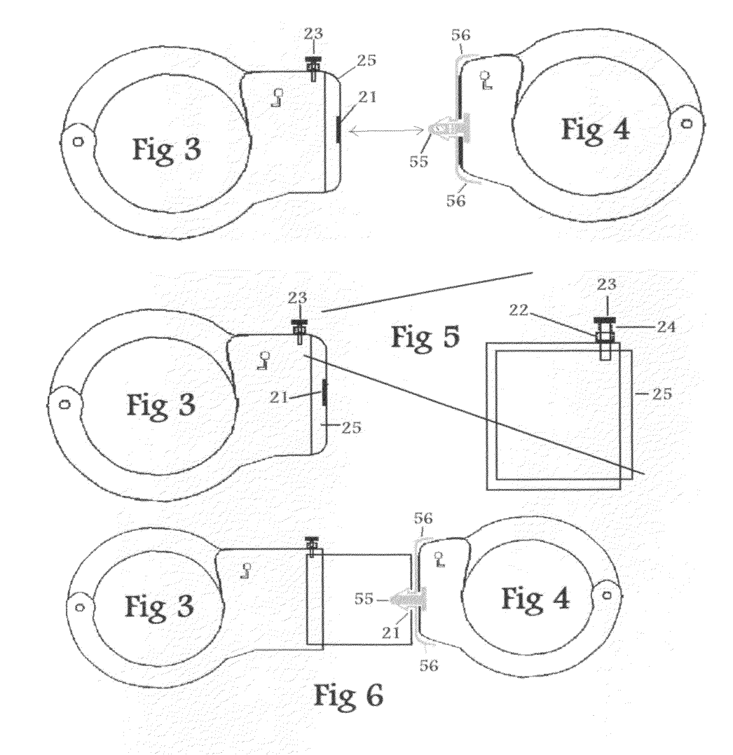

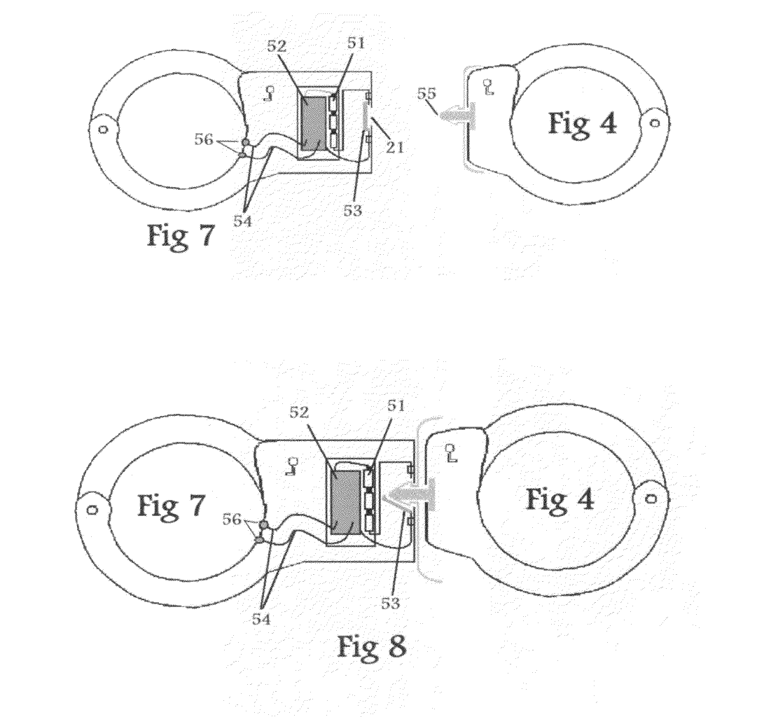

FIG. 3 main/first bracelet with track locking/unlocking mechanism 23 when unlock, extendable track 25 will extend to desire length and docking hole 21 to hold second bracelet's locking/unlocking coupling 55 in docking hole 21 by pushing in locking/unlocking coupling 55 into docking hole 21. In order to unlock the second bracelet's (FIG. 4) locking/unlocking coupling from main/first bracelet (FIG. 3), just press top and bottom handle 56 at same time and pull back second bracelet (FIG. 4) out from main/first bracelet (FIG. 1)

FIG. 5 is enlarged view of extendable/retractable track 25 locking/unlocking mechanism 23 is seated in side of holder 22 with turning groove 24 when turn clock wise locking/unlocking mechanism 23 will go downward to lock extendable/retractable track 25 in place. When turn counter clock wise locking/unlocking mechanism goes up and release extendable/retractable track 25 from locked position to be moved to desire length.

FIG. 6 is main/first bracelet (FIG. 3) and second bracelet ( FIG. 4) put together by docking hole 21 and locking/unlocking coupling 55 by pushing locking/unlocking coupling 55 into docking hole 21. And extendable/retractable track 25 is extended.

FIG. 7 is main/first bracelet (FIG. 3) having a stunning mechanism 52 where battery 51 is supplying the power to stunning mechanism 52 and voltage is transfer by wire 54 to contact point 56 where jolt of electricity is release to stop the resisting subject by having only one cuff on. When subject are not resisting officer can put second bracelet's locking/unlocking coupling 55 into main/first bracelet's docking hole 21, where there is a off switch 53 is push out from contact point, which will shut off the stunning mechanism 52.

FIG. 8 is main/first bracelet (FIG. 7) attached with second bracelet (FIG. 4) which push off stunning mechanism's 52 switch 53 to a off position to not to shock the subject since both of the bracelet are secure.

I claim:

1. A restrain device comprising a first bracelet and second bracelet wherein; least one bracelet contain a retraction/extension mechanism having line operatively attach thereto, and other end of the line is operatively attached to other bracelet, and once said first bracelet contain a retraction/extension are closed, control device release one way locking device to be engages with retraction/extension mechanism in retract only mode and once said bracelet contain a retraction/extension are open, control device let one way locking device disengage from retraction/extension mechanism, in order to said second bracelet retract or extend.

2. A restrain device of claim 1, wherein said second bracelet containing a locking/unlocking coupling.

3. A restrain device of claim 1, wherein said first bracelet having docking hole to be attachable by said second bracelet's locking/unlocking coupling.

4. A restrain device comprising a bracelet wherein;
A bracelet with docking hole.

5. A restrain device of claim 4, wherein said bracelet with docking hole, comprising; a stunning device

6. A restrain device of claim 4, wherein said bracelet with docking hole, comprising; a extendable/retractable track.

7. A restrain device of claim 4, wherein said extendable/retractable track having a docking hole to be attachable by other coupling.
